(19) United States
(12) Patent Application Publication
(10) Pub. No.: US 2002/0139217 A1
(43) Pub. Date: Oct. 3, 2002

(54) Adjustable and foldable stem and bearings for wheeled vehicles

(76) Inventors: David Montague, West Newton, MA (US); Harry Montague, Brookline, MA (US)

Correspondence Address: SUGHRUE, MION, ZINN, MACPEAK & SEAS, PLLC, 2100 PENNSYLVANIA AVENUE, N.W., Washington, DC, 20037-3213, US

(21) Appl. No.: 09/823,765

(22) Filed: Apr. 3, 2001

(51) Int. Cl. B62D 1/18

(52) U.S. Cl. 74/493

(57) ABSTRACT

A steering assembly for connecting the front wheel and handlebar of a bicycle or other wheeled vehicle to the frame. A steerer tube is connected to the front wheel and passing through a head tube on the frame. A stem connects the steerer tube to the handlebar, and bearings on the top and bottom of the head tube which allow the steerer tube to pivot axially inside the head tube. The top of the steerer tube extends above the bearings and is slotted and fitted with a quick release clamping device which allows the stem to be raised and lowered inside the steerer tube. The sides of the stem are channeled such that the stem cannot rotate axially inside the steerer tube and the upper portion of the stem can be lifted out of the steerer tube, then rotated, and folded down to the side of the bicycle frame during storage. The headset bearings are either threaded to the steerer tube or threadless and held in place by an expanding mechanism which pushes upward on the bottom of the quick release mechanism and downward on the bearings.

### I. BACKGROUND OF THE INVENTION

1. Field of the Invention

This invention relates to a bicycle stem that can be raised and lowered to adjust the handle bar height and rotated 90 degrees and then folded down so that the handle bar is close to and parallel to the frame of the bicycle for storage. The stem works simply and safely with threaded or threadless steerer tubes using a minimum of materials and parts which are basically standard to the industry.

2. Prior Art

Bicycles and other wheeled vehicles are often only used occasionally and stored frequently. Yet, due to the laterally protruding handlebars, storage is not particularly convenient. To date, there have been no successful foldable handlebars to alleviate this problem. In addition, consumers are demanding more comfortable bicycles with highly adjustable handlebar positions. In recent years, a large number of adjustable stems have entered into the marketplace. These stems are, for the most part, quite heavy and only adjustable using a tool. In the prior art, there have been no stems whose height is adjustable by hand, that fold-down or that are safe, strong and not too heavy. A great number of stems have focused on being light and strong with U.S. Pat. No. 5,095,770 representative of those proposals but, all are very limited in use by not being adjustable in height by hand, and do not even consider a storage fold-down feature. U.S. Pat. Nos. 5,517,878, 5,540,457, 5,588,336, 5,687,616, 5,680,798 and 5,865,069 show stems that have become progressively heavier and more complicated without offering any adjustability, fold-down, or other meritorious features. U.S. Pat. Nos. 5,737,967 and 5,727,427 with partially folding stems, address the question of storability. U.S. Pat. No. 5,737,967 has the handle bars fold in half and back. These are held by a heavy non-adjustable stem. U.S. Pat. No. 5,727,427 rotates the handle bars 90 degrees to a vertical position in a questionable manner.

The techniques for producing a fully folding stem have in the past been limited to employing a single fixed skewed exterior hinge which in the folding process carried the handle bars through both a 90 degree turn and a drop-down of 90 degrees so that they end up parallel to and close to the frame of the bicycle. In some cases in order to end up in this same parallel position, the stem was rotated up and then down through 270 degrees which achieved the same results.

In all cases, the fundamental principle was that by positioning the hinge in one fixed skewed position, the folding process could be done with a single motion. Although this seems a simpler concept than dividing the folding motion into two parts as done in accordance with this invention, it relies on concept which weakens the stem in the rideable position. That is, a hinge becomes a structural component of the stem when the vehicle is being ridden and this weakens the stem. No matter how well the hinge is made, it allows motion between the connected parts which translates into unwanted motion in the handlebar during riding and weakens the performance of the bicycle. In addition, when the hinge is skewed to one side it creates an unbalanced fastening situation. Finally, when a single rotation of the handle bars is up, back over, and down to reach the folded position, the length of the brake and the derailleur cables must be extra long to handle this extended travel. U.S. Pat. Nos. 5,269,550 and 5,440,948 with their rear hinges show all these defects, and require a tool to operate.

None of the prior art incorporates methods that allow for user error. In many cases, after folding, the handlebar and stem assembly may appear to be ready to be ridden but in fact is not locked into place. Consequently, there is a serious safety issue in these prior art mechanisms.

### II. SUMMARY OF INVENTION

To overcome the above-noted defects in the prior art, this invention uses a very simple, exterior mounted locking means on the extended threaded or threadless steerer tube. It keeps the interior of the steerer tube clear, and employs an interior, hand-adjustable, full range height adjusted stem and handle bar. The invention uses the extended steerer tube for strength and does not use the pivot hinge as a structural member during riding by placing the folding hinge inside or as part of a non-stressed outside position for safety. The invention is accomplished with a minimum of materials, using those that are standard with the industry. Implementation of the invention is extremely easy to use the very first time—simply unlock by hand, lift, turn, and fold down, Finally the invention works on standard large or small wheel folding or non-folding bicycles.

It is the objective of this invention to define a safe, adjustable, folding stem for a bicycle, a folding bicycle, a motor bicycle, or other wheeled vehicle. This invention comprises a stem which can be adjusted in height without the use of tools, and which can be easily folded down and out of the way for storage. The folding process is accomplished simply by unlocking a quick release, lifting the stem, rotating it approximately 90 degrees, and folding it downward. A frame mounted bracket could be included to hold them handlebar in the folded position.

The invention employs a stem section holding the handlebars at one end and a pivoted and hinged mechanism at the other end which is restrained from pulling out or off the steerer tube. This stem section is able to rotate 90 degrees and in addition, drop down 90 or more degrees so that the handle bars in the folded position are set close to and approximately parallel to the frame of the bicycle.

While performing the fold-down feature the handle bars and interior stem are adjustable by hand for different riding heights. Both interior and exterior hinges include a safety feature against lateral turns with their grooved construction, and a safety feature against folding down during riding by using the interior and exterior surface of the extended steerer tube to prevent the hinging motion, meanwhile remaining light in construction and easy to build.

Using the interior hinge, the steerer tube is fixed onto the stem using a standard slotted clamping device with a quick-release. This clamping collar is bolted to the steerer tube or for threaded steerer tubes, is threaded, then bolted on. Because this clamping collar has protrusions that fit into the stem's continuous slots, it permits the stem to be raised and lowered while always keeping its alignment. This allows the rider to steer the bicycle even if he or she forgets to lock the quick release clamping device. When the stem is pulled all the way up where the protrusions come out of the slots, the stem can be rotated. At this point the hinge is outside the headset and the bottom section of the hinged stem hits the protrusions forcing it to remain inside the steerer tube.

The means of hinging can be as flexible as a bungee cord or rigid using pinned metal construction. The final positioning of the handle bars is determined when using interior metal hinges by: (a) the length of the vertical and forward-thrust sections of the stem; (b) the basic alignment offset between hinge and the line of the bicycle; (c) the amount of skewing to the side of the hinge; and (d) the angle of rotation before folding down and the amount of fold-down. The handlebars may end up on either side of the vehicle at a wide range of angles. All these are adjusted for folding, non-folding, large wheel or small wheel bicycles. Minor adjustments are made for when a threaded or threadless steerer tube is used, but in general, the threaded construction has a smaller and lighter locking nut and washer than the three-part locking necessary for the threadless construction.

When the rotating quill device is used, the interior bolt, as in a standard quill is tightened and draws the sloping surfaces against one another jamming the quill section against the inside of the steerer tube, thus locking the headset. To fold this version, the sloping (approximately 45 degrees) surfaces rotate relative to one another forming approximately a 90 degree fold.

### IV. BRIEF DESCRIPTION OF THE DRAWING

FIG. 1 is a perspective view with a pulled-up and then folded steering assembly using a threadless steerer tube;

FIG. 2 is a bottom view section through the hinge area;

FIG. 3a is a front view of the hinge area;.

FIG. 3b is a front view of a skewed hinge;

FIG. 3c is a front view of the hinge area with a elastic cord;

FIG. 4a is a top view of the top collar showing the hinge mechanism;

FIG. 4b is a side view section through a threadless steerer tube with a headset quick release collar with the stem not illustrated;

FIG. 4c is a view of the tightening flange for a threadless steerer tube;

FIG. 4d is a view of the headset threaded flange for a threadless steerer tube;

FIG. 4e is a side view section through the threaded steerer tube without the stem;

FIG. 4f is a view of one embodiment of the threaded top quick release clamping collar;

FIG. 4g is a view of the headset top nut set with a gap between it and the top quick release clamping collar for threaded steerer tube;

FIG. 4h is a view of the threaded steerer tube standard headset washer;

FIG. 5a is a side view section of the angled headset showing the folded stem beyond parallel to the bicycle;

FIG. 5b is a top view of the angled headset showing the folded stem beyond parallel to the bicycle;

FIG. 6a is a side view of the front end of a bicycle showing the folding stem raised out of the headset;

FIG. 6b is a side view showing the raised folding stem turned 90 degrees;

FIG. 6c is a side view showing the folding stem folded down parallel to the bicycle;

FIG. 6d is a side view showing the 22 degree offset-hinge folding stem folded down parallel to the bicycle;

FIG. 6e is a side view showing the offset-hinge folding stem folded down parallel to a center fold folding bicycle;

FIG. 6f is a side view showing the offset-hinge folding stem with a seat tube fold on a folding bicycle;

FIG. 7a is a side view section of a composite ride and fold position illustration of a threadless steerer assembly with a stem quick release surround;

FIG. 7b is a partial front view of FIG. 7a;

FIG. 8a is a side view section showing the folded position of a threadless steerer tube with an exterior hinge;

FIG. 8b is a partial front view of FIG. 8a in the riding position;

FIG. 9a is a side view showing the folded position of a threadless steerer tube with an exterior hinge and star nut;

FIG. 9b is a front view of FIG. 9a;

FIG. 10a is a front view of a rotating quill interior hinge design in the folded position with the handle bars parallel to the bicycle;

FIG. 10b is a front view of a rotating quill interior hinge design in the unfolded, raised position with the handle bars rotated to the opposite side;

FIG. 10c is a side view of a rotating quill interior hinge design in the riding position with the entire quill and handle bars turned to the front, in the riding position; and

FIG. 11 is a side view of a rotating quill design with the hinge located below the quill.

### V. DESCRIPTION OF THE PREFERRED EMBODIMENTS

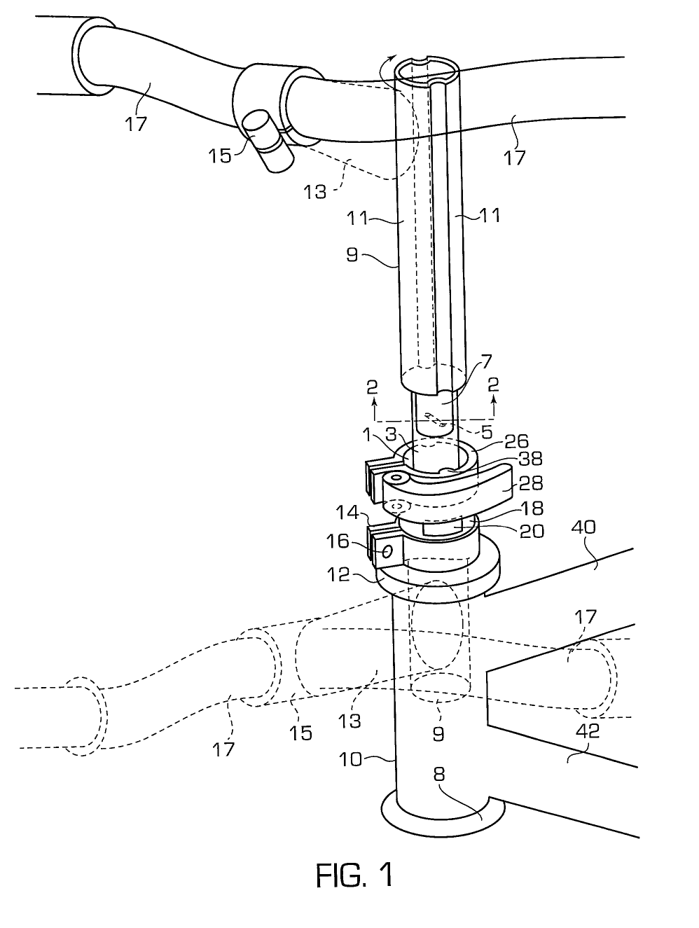

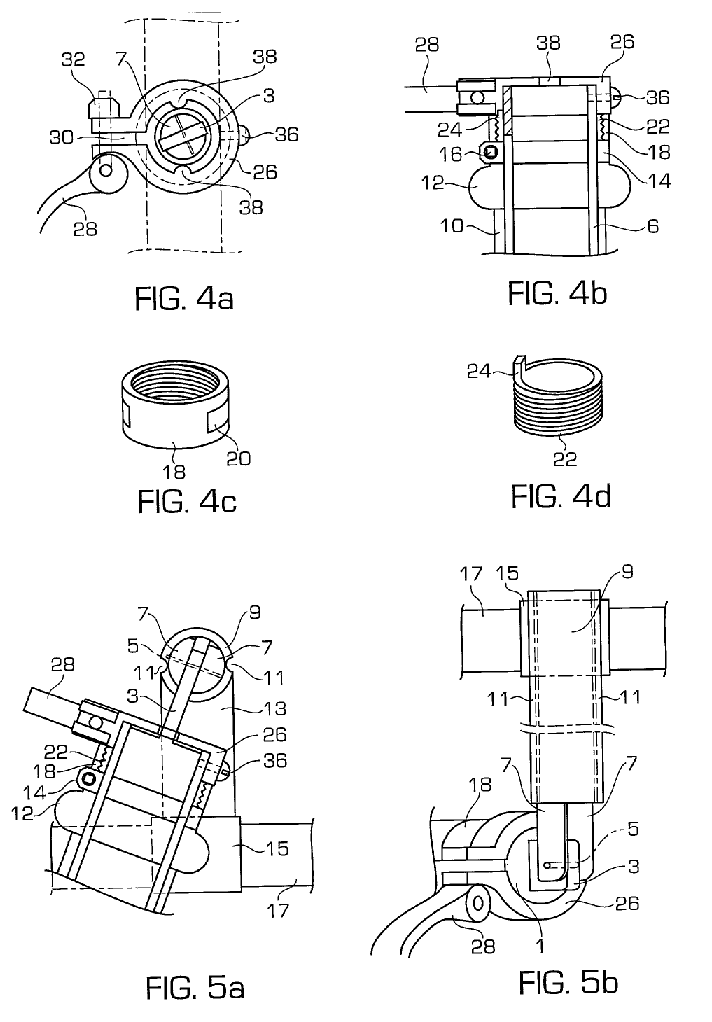

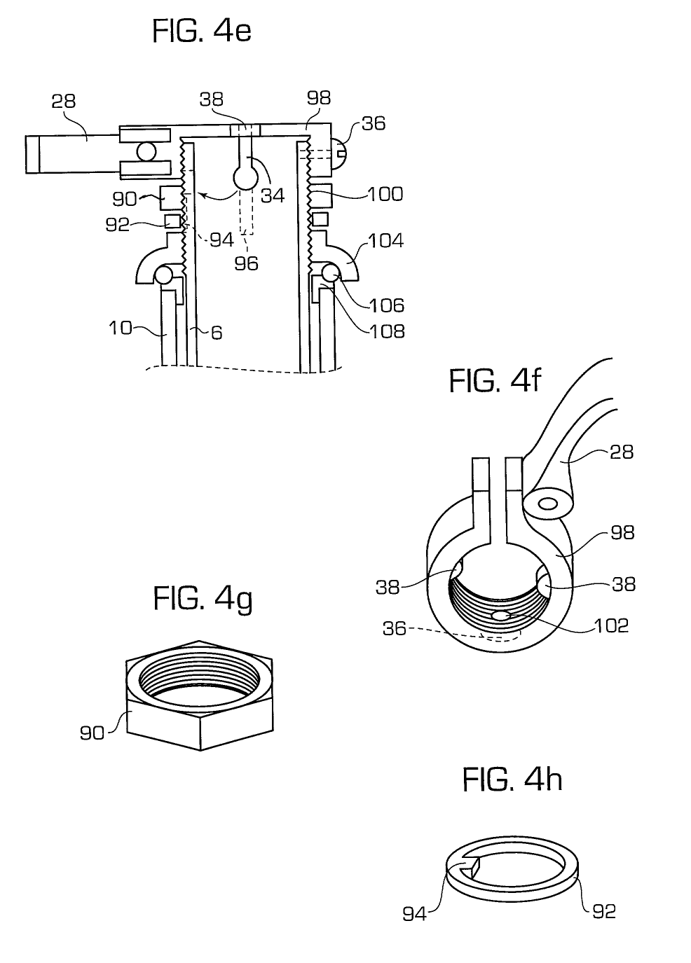

In all of the embodiments, the parts which raise and lower with the stem are designated with odd numbers and the fixed stem parts and bicycle connecting parts are designated with even numbers. In FIG. 1, the vehicle head tube 10 holds the standard top and bottom bearings 8 and 12 of a standard threadless headset. The top clamping collar 26 is bolted to the steerer tube. Below the clamping collar, as illustrated in FIG. 4b but shown in FIG. 1, is the smooth interior-threaded exterior flange 22 that has a tooth projection 24 which fits up into the quick release slot of the upper collar. Threaded on this flange is an adjuster-tightening flange 18 with wrench slots 20 which tightens down onto the slotted clamp 14 with its Allen key bolt 16. This pressure adjuster system is clearly shown in FIG. 4b which illustrates the quick release 28, slot 30, and nut 32 on the slotted collar 26 secured to the steerer tube 6 with the set screw 36.

The clamping collar, as shown in FIG. 4a, has projection 38 which guides the vertical section of the stem. In FIG. 1, the top and bottom vehicle tubes 40 and 42 complete the fixed elements.

FIG. 1 along with FIGS. 4a, 4b, 4c and 4d illustrate an adjustable folding stem used with a standard threadless steerer tube and headset. FIGS. 4e, 4f, 4g and 4h show a threaded steerer tube setup and this head set construction can be substituted for 4a, 4b, 4c and 4d using the same stem as shown in FIG. 1. FIG. 4e shows the steerer tube threaded all the way down to the top race 108 which is wedge fit into the outer head tube 10. The ball bearings 106 ride between the race 108 and the upper bearing cup 104 which is threaded onto the steerer tube 6. The standard head set washer 92 shown in FIG. 4h with inward set tooth 94 slides down on the bearing cup 104, its tooth 94 fitting in the groove 96 below the slot 34 which as the arrow indicates belongs under the collar quick release slot shown on FIG. 4f.

FIG. 4g shows the standard headset nut 90 which tightens down onto to the bearing construction but does not touch the top collar 98 shown in FIG. 4f. This collar 98 is threaded onto the top thread portion 100 of the steerer tube and is correctly secured so the projections 38 are perpendicular to the bicycle with the small bolt 36 coming through the hole 102.

In FIG. 1 the stem is shown pulled all the way up ready to turn and fold. The bottom plug 1 of the lower part of the stem cannot be raised higher because of the collar 26 projections 38. When the lower tooth of the hinge 3 is rotated it does not hit the projections 38. The lower tooth 3 is pinned to the upper teeth 7 with the pin 5. The vertical stem 9 can be of varying lengths depending on the range of adjustability desired and whether it is used with large or small wheel bicycles. The indentations 11 house the collar projections 38 and keep the stem from rotating in case binder 28 is not locked during riding. The standard stem forward thrust member 13 holds the standard clamp 15 and handle bars 17.

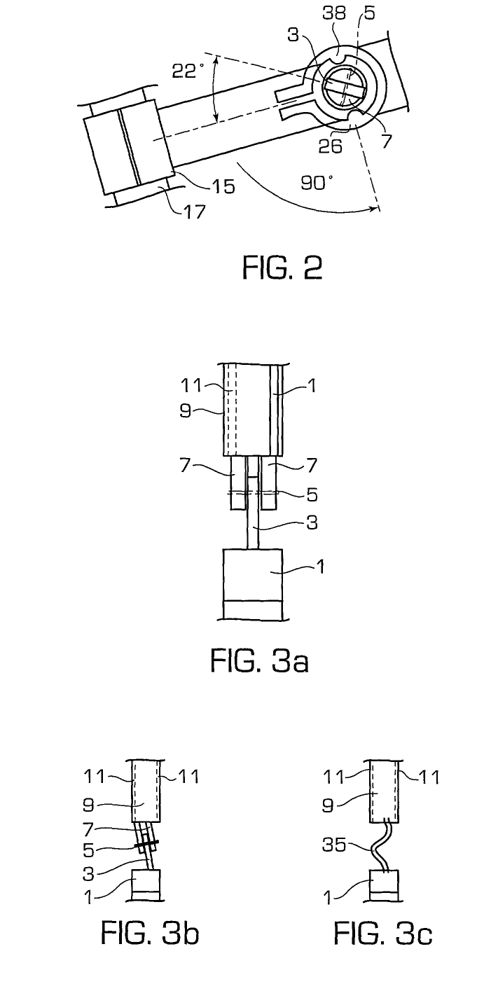

FIG. 2 is a bottom sectional view looking up showing the 22 degree offset between the hinge direction and the forward-thrust stem section. Variations of the 22 degree angle change the folded position of the handlebar. If the 22 degrees is reduced to zero, the handlebars will end up folded perpendicular to the steerer tube. A negative angle can also be used to position the folded handlebars on the opposite side of the bicycle. FIG. 3a is a front view of the hinge construction showing the skewed stem slots 11. FIG. 3b is a front view of the hinge construction showing the variation of skewing the hinge to change the position of the folded members. FIG. 3c shows the introduction of an elastic chord 35 to replace the hinge in a less expensive model.

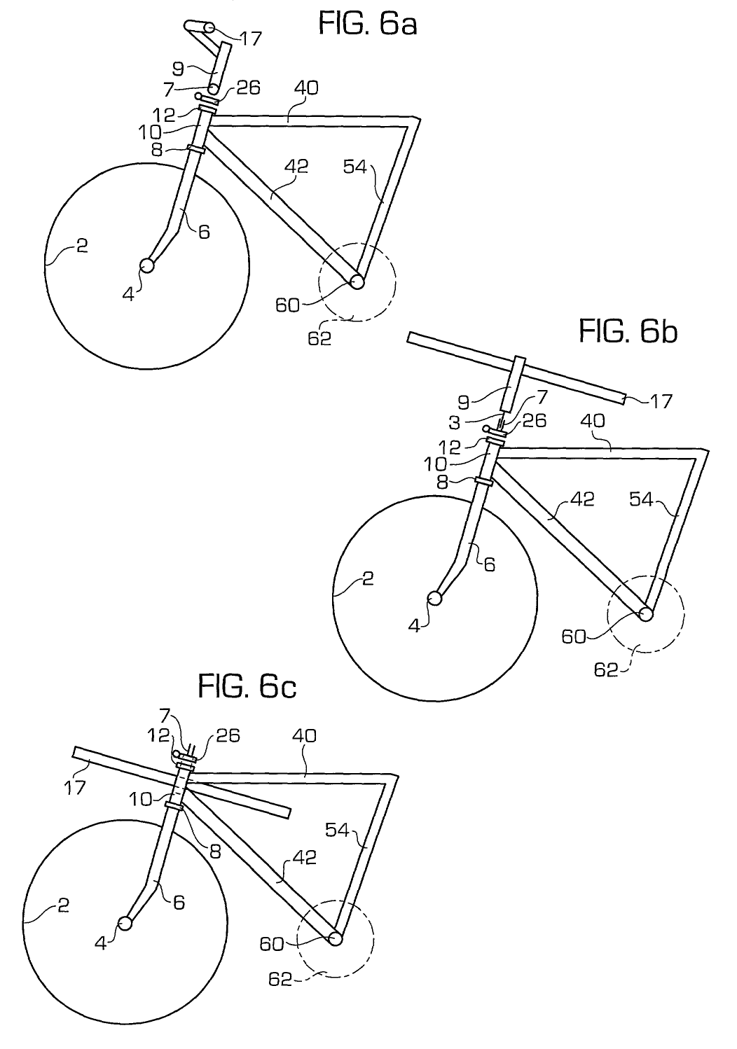

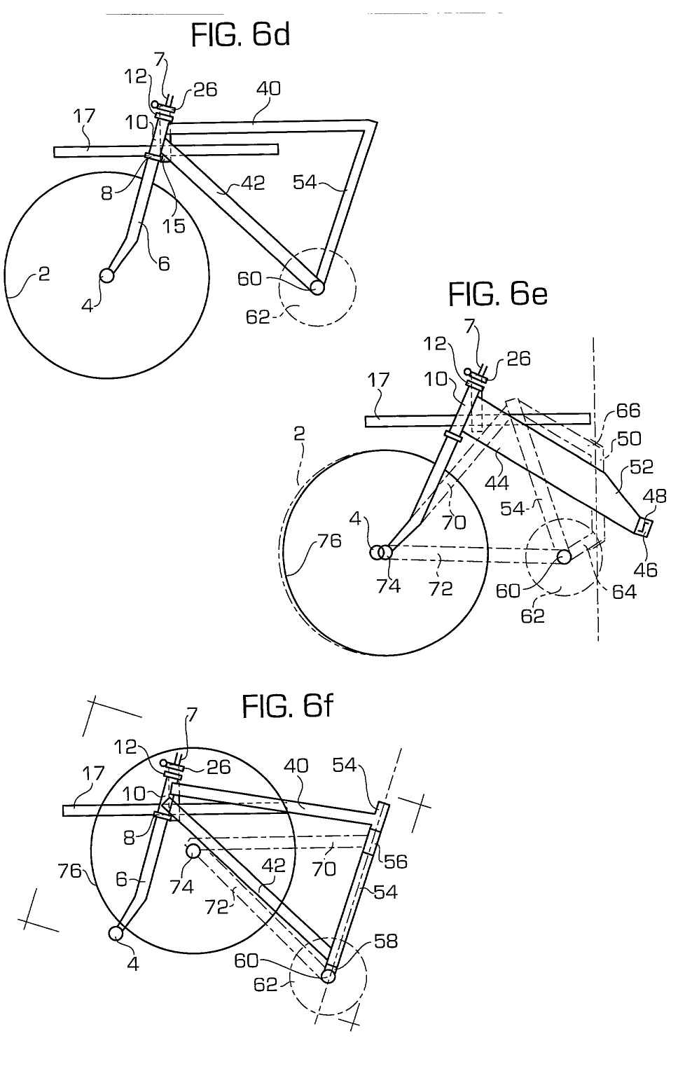

FIG. 5a is a side view using the threadless head set and stem construction of FIGS. 4a, 4b, 4c and 4d and with the stem and handle bars in a folded position parallel to the bicycle. As shown in FIG. 5a the 22 degree skewed angle of hinge with vertical stem section 9 in a horizontal position causes the throw section of the stem 13 to drop vertically and the handle bars to be approximately parallel to the ground as shown also in FIG. 6d. FIG. 5b is a top view of FIG. 5a.

The diagrams of FIGS. 6a through 6f show the handle bar positioning as it relates to folding and non-folding bicycles. FIG. 6a is the diagram as shown in FIG. 1 with the handle bar and stem pulled all the way up. FIG. 6b shows the handle bar rotated 90 degrees. FIG. 6c shows the handle bar folded down and perpendicular to the head set as if the offset angle were zero. FIG. 6d shows the handle bar folded down and parallel to the ground as if the offset angle were 22 degrees. FIG. 6e shows the same fold but used with a center folding bicycle with the front and back wheels lined up, and FIG. 6f shows the same with a seat tube folding bicycle with the front wheel removed. The standard front frame construction is made up of the top tube 40, down tube 42, and seat tube 54 with crank 60 and chain wheel 62. The center fold bicycle shown in FIG. 6e has a center bar 44, a center member 50, a center pivot 52, and a seat tube restraint plate 46 with locking bolt 48. The back frame has seat stay 70 and chain stay 72 holding rear axle 74 and rear wheel 76. In FIG. 6f, the seat tube fold has top and bottom seat tube collars 56 and 58.

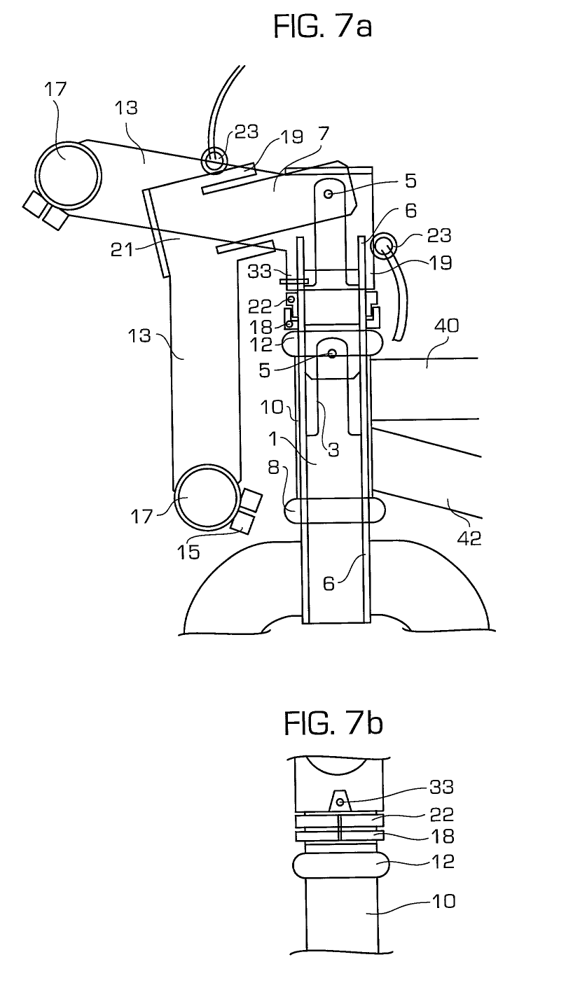

FIG. 7 illustrates a second embodiment which employs an extended steerer tube and an internal hinge, but does not slot the upper steerer tube for clamping on to the stem. FIG. 7a shows a standard threadless steerer tube with a threaded slotted locking nut 22 tightened onto the steerer tube and threaded onto a second slotted locking nut 18 which applies pressure on the standard threadless headset bearing member 12. As in the other configurations illustrated in FIGS. 1 to 6, the steerer tube extends beyond the bearing for locking and securing the folding stem. In the case of FIG. 7a, however, the locking quick release rides with the vertical folding stem section 21 with slotted area 19 which wraps around and is squeezed onto the steerer tube 6.

A wedge 33 is pinned to the steerer tube and the member 21 has a wedge slot that fits onto this during riding to prevent rotation in case the quick release is not tightened during riding. This wedge and slot are clearly shown in the front view in FIG. 7b but could be replaced with the channel 11 and protrusions 38 of FIG. 1. FIGS. 7a and 7b show a folding, non-adjustable stem. However, if the steerer tube was threaded on the inside and an additional inside threaded tube were added, this tube could house the smaller diameter vertical stem and telescope up to adjust the handle bar height.

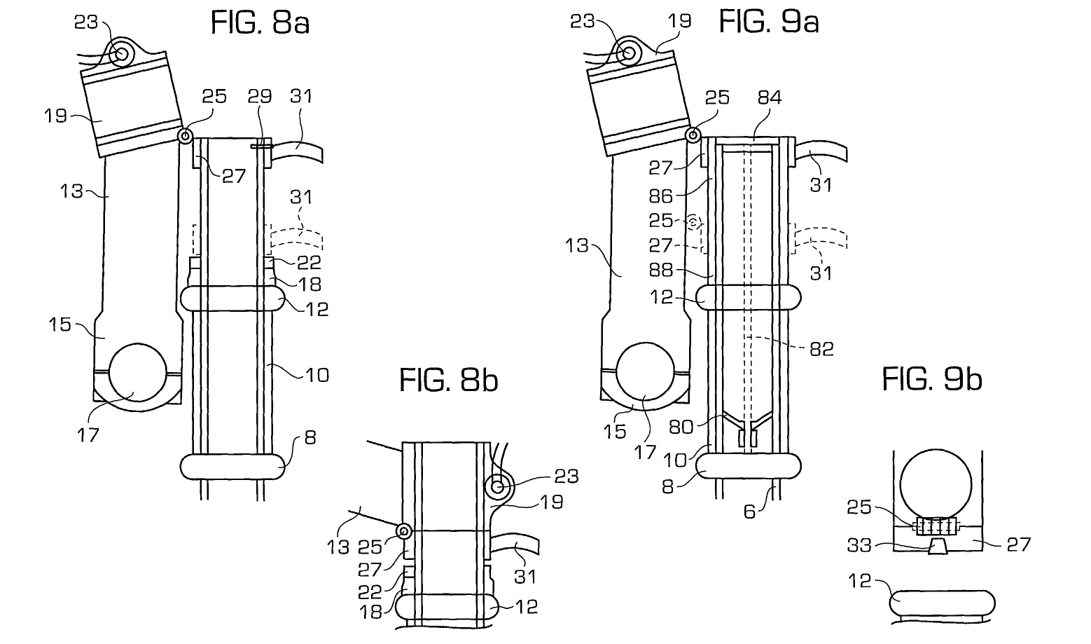

FIG. 8 shows a third embodiment which employs the extended steerer tube found on other embodiments but in this case the top is not slotted and there is no internal hinge. FIG. 8a is a front view of a folded threadless steerer tube with an exterior collared vertical upper stem section 19 and lower section 27 raised and lowered onto the steerer tube and hinged at 25, stopped from pulling out with pin 29 and having a handle 31. As shown in FIG. 7a, a locking and tightening threaded nut and flange apply pressure on the bearing set. FIG. 8b shows the locked riding position of FIG. 8a. FIG. 9a is a threadless steerer tube with the same folding system but with a star-nut head set construction in lieu of the standard flange and nut of FIG. 7a. FIG. 9b illustrates the riding position of this embodiment.

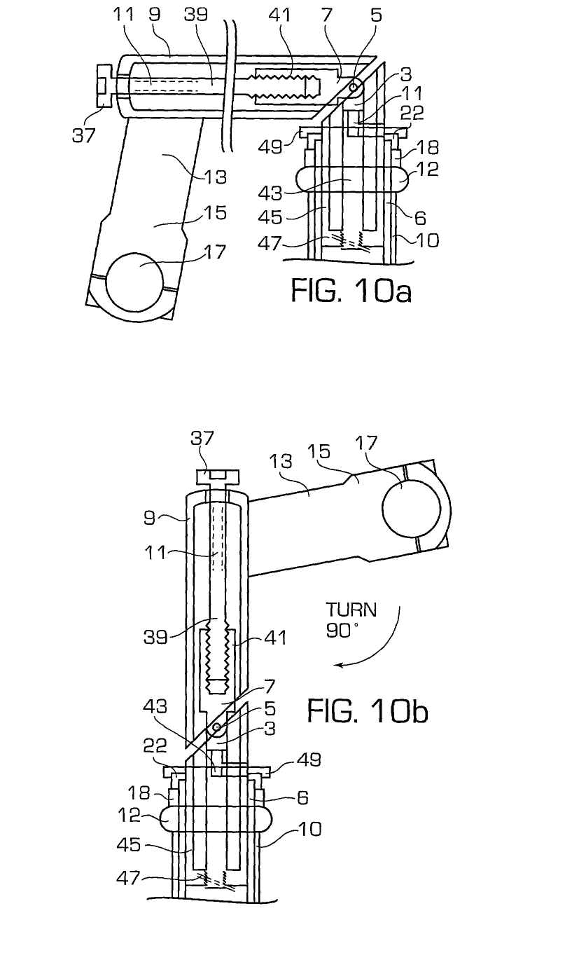

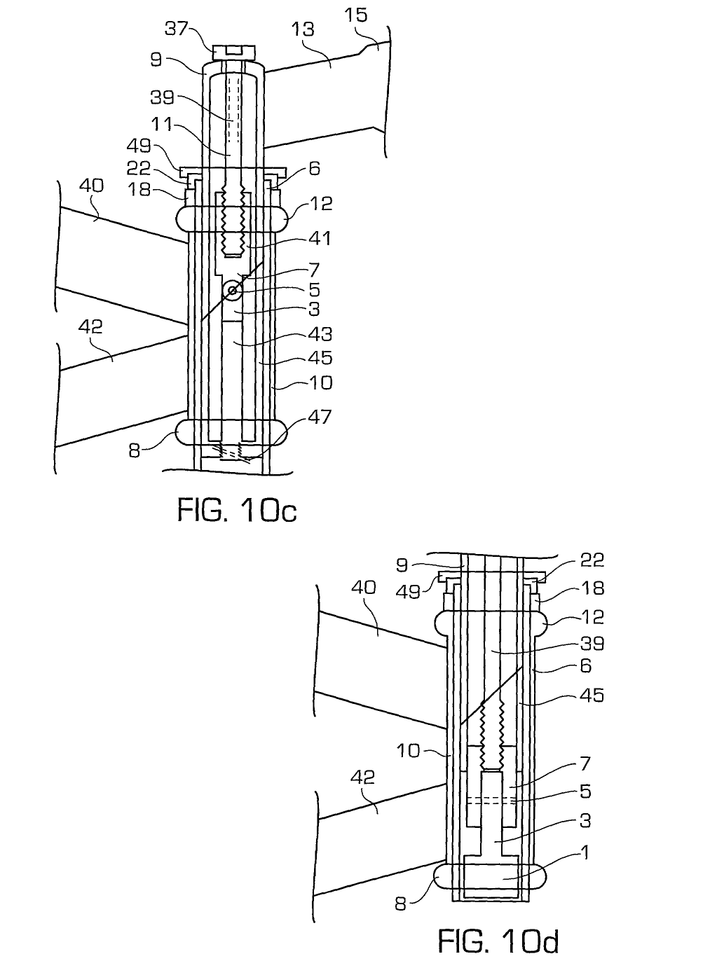

FIG. 10 shows a fourth embodiment which employs the internal hinge concept of other embodiments, however, it uses a quill type method for locking and it does not use the extended steerer tube used in all other embodiments. FIG. 10a shows the handle bar in the folded position parallel to the bicycle. The upper section of quill stem 9 has the continuous anti-rotation slots 11 on each side and alien key or quick release 37 tightens the hinge quill bolt 39, turning in the threaded section 41. This is attached to the upper hinge section 7 with pins to lower section 3 which is part of the bolt 43 which is screwed in to the lower section of the quill 45 which is partially slotted 11 as shown. When folding the stem, the lower quill section 45 is being pulled up it is stopped by a protrusion collar 49 which has been screwed onto and pinned to the standard top threaded nut 22 after it has been set. These protrusions and slots are an alignment guide for the head set and are optional.

FIG. 10b shows the handle bar rotated 180° to the opposite side. Since bolt 39 rotates freely with respect to the upper quill section 9, it and the hinge and the lower section 43 can remain unturned always aligned with the quill 45° sloping surfaces. The next step is the entire quill stem is turned 90° to face front. FIG. 10c shows the side view with bolt 39 tightened down in the threading 41 activating the sliding quill action and securing the handle bars in the standard manner.

FIG. 11 shows the entire hinge mechanism set below and attached to the bottom section 45. Again the protrusions and slots would be optional.

It will be appreciated that modifications of this invention may be practiced without departing from the scope of this invention. For example, the quick release used in the embodiments could be replaced by a bolt or wing nut or other tightening technique.

What is claimed is:

1. A steering assembly for a wheeled vehicle comprising; a handlebar assembly, a stem supporting the handlebar assembly, headset bearings and a steerer tube extending above the headset bearings, said steerer tube being slotted to allow clamping onto said stem.

2. A steering assembly of claim 1, further comprising a stem section having a clamping device which is adjustable in height, wherein the steerer tube in fixed onto said stem section.

3. A steering assembly for a wheeled vehicle wherein the stem assembly has an internal hinge which, when raised above the steerer tube, allows the stem to rotate axially and then fold down for storage.

4. A steering assembly of claim 1 wherein the steerer tube comprises at least one internal protrusions which fits into a longitudinal channel in the stem and does not allow the stem to rotate axially.

5. A steering assembly of claim 2, further comprising means for adjusting said headset bearings using a longitudinal force exerted downward, said means expandable between the clamping device and the headset bearings.

6. A steering assembly wherein the stem and handlebar assembly is moveable to be lifted, rotated concentrically in the steerer tube, and then folded down for storage.

7. A steering assembly wherein the stem and handlebar assembly is moveable to be lifted, folded down, and then rotated concentrically in the steerer tube.

8. A steering assembly of claim 1 further comprising a hinge for said stem assembly, said hinge located external to the steerer tube, which, when raised above the top of the steerer tube, allows the stem to rotate axially and then fold down for storage.

9. A steering assembly of claim 1, further comprising an elastic cord wherein the stem assembly is attached to the vehicle using said elastic cord, and when the stem is raised above the steerer tube, it may fold down for storage.

10. A steering assembly of claim 1, further comprising at least one external protrusion, wherein the stem is equipped with at least one external protrusion which fits into a longitudinal channel in the inner surface of the steerer tube and do not allow the stem to rotate axially.

11. A steering assembly of claim 1 wherein the steerer tube in fixed onto a stem using a manually operated clamping device and is adjustable in height.

12. A steering assembly of claim 2 wherein said clamping device is attached to the steerer tube.

13. A steering assembly of claim 1 further comprising clamping means, wherein the steerer tube in fixed onto a stem using said clamping means attached to the stem.

14. A steering assembly of claim 2 wherein said clamping device is attached to the steerer tube by means of a threaded member.

15. A steering assembly of claim 2 further comprising at least one internal protrusion associated with said clamping device, said at least one protrusion which extend above and past the top rim of the steerer tube into the area occupied by the stem.

16. A steering assembly of claim 1 further comprising a threaded upper portion of the steerer tube, a threaded the inner surface of the clamping device, and threaded upper headset bearing parts thereby allowing assembly together by threading the upper headset parts and the clamping device onto the steerer tube.

17. A steering assembly of claim 3 further comprising internal protrusions on a portion of clamping device below the hinge, wherein said stem is restrained from exiting the steerer tube by said internal protrusions on the clamping device.

18. A steering assembly of claim 3 further comprising internal protrusions in said steerer tube, wherein the portion of the stem below the hinge is restrained from exiting the steerer tube by means of said internal protrusions in the steerer tube.

19. A steering assembly for a wheeled vehicle, comprising, a steerer tube having a clamping device, a stem mast positioned concentrically inside the steerer tube, headset bearings for said steerer tube, wherein the steerer tube extends above the headset bearings and is fitted with said clamping device which in turn clamps onto said stem mast.

20. A steering assembly of claim 8 wherein the hinge is restricted from folding by the extended steerer tube while the vehicle is operated.

21. A steering assembly of claim 1 further comprising a longitudinal channel on the inside of the steerer tube, wherein the stem is equipped with at least one external protrusion which fits into said longitudinal channel and does not allow the stem to rotate axially.

22. A steering assembly of claim 3 further comprising a bolt extending vertically from a hand operated locking mechanism at the top downward internally in the stem, and equipped with a hinge located at the junction of a wedge shaped lower piece and its angled lower surface.

23. A steering assembly of claim 22 wherein the folding surface further comprises an inclined quill surface as a rotational face about which the stem can reach the folded position.

24. A steering assembly, comprising:
a head tube, connected to a vehicle frame;
a steerer tube connected between a wheel and a stem and passing through the head tube and extending above the upper bearings;
a quick release binding collar equipped with protrusions extending inward, said quick release connected to the upper portion of the steerer tube above the bearings;
a stem connected between the steerer tube and a vehicle handlebar, the lower portion of which is equipped with a hinge which is restricted from being removed from the steerer tube by said quick release protrusions, said stem can be lifted, rotated axially, and folded down for storage.

25. A method for folding a wheeled vehicle stem comprising the steps of; unlocking a stem, lifting the stem and rotating it on is axis, and folding the stem down for storage.

26. A method for folding a wheeled vehicle stem consisting of two steps each having a distinct motion, the first step being pivoting the stem on is axis, and the second step being folding down the stem.

27. A method for applying a vertical downward pressure to the top of a threadless bicycle headset which uses counter threaded, concentric members whereby, the inner member is restricted from spinning relative to a clamping device mounted onto the steerer tube above it, and the outer member can be threaded downward until the desired pressure is exerted on the headset whereby the members are locked into position or a lower member is locked into position.
